(19) United States
(12) Patent Application Publication
(10) Pub. No.: US 2024/0273376 A1
(43) Pub. Date: Aug. 15, 2024

(54) METHOD AND DEVICE WITH REINFORCEMENT LEARNING TRANSFERAL

(71) Applicants: SAMSUNG ELECTRONICS CO., LTD., Suwon-si (KR); Seoul National University R&DB Foundation, Seoul (KR)

(72) Inventors: Minsu KO, Suwon-si (KR); Jae Kyeom KIM, Seoul (KR); Gun Hee KIM, Seoul (KR); Seo Hong PARK, Seoul (KR); Sungjoo SUH, Suwon-si (KR)

(73) Assignees: SAMSUNG ELECTRONICS CO., LTD., Suwon-si (KR); Seoul National University R&DB Foundation, Seoul (KR)

(21) Appl. No.: 18/475,654

(22) Filed: Sep. 27, 2023

(30) Foreign Application Priority Data
Feb. 2, 2023 (KR) 10-2023-0014465

(51) Int. Cl. G06N 3/092; G06N 3/096

(52) U.S. Cl. CPC G06N 3/092; G06N 3/096

(57) ABSTRACT

A method and device with transferal of reinforcement learning are disclosed. The method includes: approximating an optimal value-function for a task vector using a value approximator trained to output a minimum value-function using a state of an agent and source task vectors; determining an upper bound of the optimal value-function for the task vector; determining a lower bound of the optimal value-function for the task vector; correcting the optimal value-function for the task vector based on the upper bound and the lower bound; and determining an optimal policy for the task vector using the corrected optimal value-function for the task vector.

### CROSS-REFERENCE TO RELATED APPLICATIONS

This application claims the benefit under 35 USC § 119(a) of Korean Patent Application No. 10-2023-0014465, filed on Feb. 2, 2023, in the Korean Intellectual Property Office, the entire disclosure of which is incorporated herein by reference for all purposes.

### BACKGROUND

### 1. Field

The following description relates to a method and device with reinforcement learning transferal.

### 2. Description of Related Art

A goal of reinforcement learning is to maximize a reward given from outside. Depending on a reinforcement learning method, an agent may be trained with a goal of maximizing a predetermined reward function.

Transfer learning may be used to respond to other tasks having a new reward function or time different from the learning time of an agent using an agent trained according to a specific reward function at a specific time.

Depending on a transfer learning method, an agent may have high performance in target tasks using policies trained in source tasks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: one or more processors; and a memory electrically connected with the one or more processors and storing instructions configured to cause the one or more processors to: approximate an optimal value-function for a task vector using a value approximator trained to output a minimum value-function using a state of an agent and source task vectors; determine an upper and lower bound of the optimal value-function for the task vector; value-function correct the optimal value-function for the task vector based on the upper bound and the lower bound; and determine an optimal policy for the task vector using the corrected optimal value-function for the task vector.

The task vector may be represented as a linear combination of the source task vectors.

The instructions may be further configured to cause the one or more processors to: determine a number of combinations of the linear combination of the source task vectors to represent the task vector according to a threshold; and determine the upper bound according to one of the determined linear combinations of the task vectors.

The lower bound may be determined based on an approximation of, and an approximation error of, the optimal value-function.

The upper bound may be determined based on an arbitrary linear combination of the source task vectors to represent the task vector.

The instructions may be further configured to cause the one or more processors to correct the optimal value-function in a range of less than or equal to the upper bound and greater than or equal to the lower bound.

The instructions may be further configured to cause the one or more processors to: approximate a minimum value for the task vector using a minimum value approximator trained to output a minimum value for the source task vectors; and determine the upper bound using the minimum value for the task vector.

The optimal policy may include a neural network model.

In another general aspect, a method of transferring reinforcement learning includes: approximating an optimal value-function for a task vector using a value approximator trained to output a minimum value-function using a state of an agent and source task vectors; determining an upper bound of the optimal value-function for the task vector; determining a lower bound of the optimal value-function for the task vector; correcting the optimal value-function for the task vector based on the upper bound and the lower bound; and determining an optimal policy for the task vector using the corrected optimal value-function for the task vector.

The task vector may be represented as a linear combination of the source task vectors.

The determining of the upper bound of the optimal value-function for the task vector may include: determining a number of combinations of the linear combination of the source task vectors to represent the task vector by a predetermined threshold; and determining the upper bound according to a combination of the linear combination of the source task vectors.

The lower bound may be determined based on an approximation of, and an approximation error of, the optimal value-function for the task vector of policies based on the source task vectors.

The policies may include respective neural networks trained with respect to the source task vectors.

The upper bound may be determined based on a combination of the linear combination of the source task vectors to represent the task vector.

The correcting of the optimal value-function for the task vector may include correcting the optimal value-function for the task vector in a range of less than or equal to the upper bound and greater than or equal to the lower bound.

The method may further include approximating a minimum value for the task vector using a minimum value approximator trained to output a minimum value for the source task vectors, where the determining of the upper bound includes determining the upper bound using the minimum value for the task vector.

In another general aspect, a method of transferring reinforcement learning includes: approximating a task vector using a task vector approximator trained to output source task vectors using source task information of source tasks; approximating a feature of the task vector using a feature approximator trained to output a feature of the source task vector based on a state of an agent; approximating an optimal value-function for the task vector using the task vector and the feature of the task vector; determining an upper bound of the optimal value-function; determining a lower bound of the optimal value-function; correcting the optimal value-function based on the upper bound and the lower bound; and determining an optimal policy for the task vector using the corrected optimal value-function.

The task vector may be represented as a linear combination of the source task vectors.

The lower bound may be determined based on an approximation and an approximation error of the optimal value-function, wherein the approximation error is based on the source task vectors.

The upper bound may be determined based on one of multiple linear combinations of the source task vectorsvalue-functionvalue-functionvalue-functionvalue-functionvalue-functionvalue-functionvalue-functionvalue-functionvalue-functionvalue-functionvalue-functionvalue-functionvalue-functionvalue-functionvalue- functionvalue-functionvalue-functionvalue-functionvalue-functionvalue-functionvalue-functionvalue-functionvalue-functionvalue-function

Other features and aspects will be apparent from the following detailed description, the drawings, and the claims.

### BRIEF DESCRIPTION OF THE DRAWINGS

FIG. 1 illustrates an example electronic device, according to one or more embodiments.

FIG. 2 illustrates an example operation of transferring a reinforcement-trained agent to a new task, according to one or more embodiments.

FIG. 3 illustrates an example method of transferring reinforcement learning, according to one or more embodiments.

FIG. 4 illustrates an example method of approximating a minimum value-function, according to one or more embodiments.

FIG. 5 illustrates an example of a range of task vectors, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

A goal of reinforcement learning is to maximize a reward given from outside (e.g., from outside an agent performing a task). In general reinforcement learning, since a goal is to maximize one reward function, an agent trained according to a reinforcement learning method has difficulties responding to a task at a time other than the learning time and/or a new reward function time.

To respond to a task having a time different from the learning time and/or the new reward function time, a transfer learning method may be used. In reinforcement learning, transfer learning may aim to make an agent operate with high performance in a target task using policies trained for source tasks.

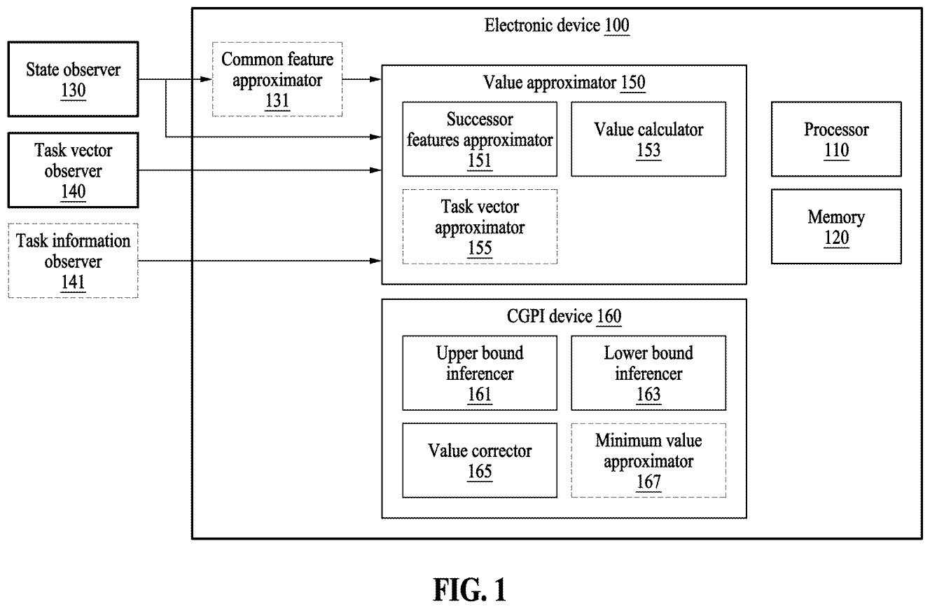

FIG. 1 illustrates an example electronic device 100, according to one or more embodiments.

Referring to FIG. 1, the electronic device 100 may include a processor 110, a memory 120, a value approximator 150, and a constrained generalized policy improvement (CGPI) device 160. The value approximator 150 may include a successor features (SFs) approximator 151 and a value calculator 153. The CGPI device 160 may include an upper bound inferencer 161, a lower bound inferencer 163, and a value corrector 165. Although the processor 110 and memory 120 are shown as separate from the other components of the electronic device 100, in practice, the other components of the electronic device 100 will be implemented in the processor 110 and memory 120.

The electronic device 100 may include policies (e.g., neural networks) trained according to reinforcement learning in source tasks (e.g., to be distinguished from the “new” tasks mentioned below). The electronic device 100 may determine an optimal value approximated in a new target task (a task other than a source task) according to a transfer learning method and determine an optimal policy, using policies trained in the source tasks (in the field of reinforcement learning, a “policy” is a usually implemented as a neural network).

The electronic device 100 may perform zero-shot transition on target tasks with the policies pre-trained in the source tasks. The electronic device 100 may perform transfer learning on new target tasks without additional training and/or fine-tuning of the policies for the new target tasks.

The electronic device 100 may perform bounding on an approximate error to improve transition performance. The electronic device 100 may calculate an upper bound and a lower bound of an optimal value in a specific target task through values produced by policies trained for source tasks, which may be done using a linear relationship between task vectors.

The electronic device 100 may limit an approximate error value for target tasks and improve zero-shot transition performance, using the upper bound and the lower bound of the optimal value with respect to the target tasks.

The processor 110 may execute, for example, instructions (e.g., a program or application) to control at least one other component (e.g., hardware or a software component) of the electronic device 100 connected to the processor 110 and may perform various data processing or computation as described herein. As at least a part of data processing or computation, the processor 110 may store a command or data received from another component (e.g., a sensor module or a communication module) in a volatile memory, process the command or the data stored in the volatile memory, and store resulting data in a non-volatile memory. The processor 110 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, and/or a communication processor (CP)) that is operable independently from, or in conjunction with the main processor. For example, when the electronic device 100 includes the main processor and the auxiliary processor, the auxiliary processor may be adapted to consume less power than the main processor or to be specific to a specified function. The auxiliary processor may be implemented separately from the main processor or as a part of the main processor.

The auxiliary processor may control at least some of functions or states related to at least one (e.g., a display module, a sensor module, or a communication module) of the components of the electronic device 100, instead of the main processor while the main processor is in an inactive state (e.g., sleep) or along with the main processor while the main processor is in an active state (e.g., executing an application). The auxiliary processor (e.g., an ISP or a CP) may be implemented as a portion of another component (e.g., a camera module or a communication module) that is functionally related to the auxiliary processor. The auxiliary processor (e.g., an NPU) may include a hardware structure that is efficient specifically for processing of an artificial intelligence (AI) model. The AI model may be generated by machine learning. Such learning may be performed by, for example, the electronic device 100 in which an AI model is executed, or performed via a separate server (e.g., a server). A learning algorithm may include, but is not limited to, for example, supervised learning, unsupervised learning, semi-supervised learning, or reinforcement learning. The AI model may include a plurality of neural network (NN) layers. An NN may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof but is not limited thereto. The AI model may additionally or alternatively include a software structure other than the hardware structure.

The memory 120 may store various pieces of data used by at least one component (e.g., the processor 110 or a sensor module) of the electronic device 100. The various pieces of data may include, for example, processor-executable instructions (e.g., a program) and input data or output data for a command related thereto. The memory 120 may include, for example, a volatile memory or a non-volatile memory.

In an SFs framework, a state of an agent (e.g., in an environment), an operation of the agent, and a reward function for a task vector according to a next state of the agent may be represented as a linear combination of a feature of each transition and a task vector.

Since a value in reinforcement learning is generally defined as a discounted sum of rewards, a value-function for an arbitrary policy (network) may be represented as a linear combination of the discounted sum of features of the transition and the task vector. The discounted sum of features of the transition may refer to SFs.

In the following, although description is provided in part using mathematical notation and formulas, it will be appreciated by technical artisans in the field of reinforcement learning (and software engineering in general) that the mathematical notation and formulas are merely an efficient language for describing actual computation by processor(s) and the technical artisan will readily be able to translate the mathematical description into code (or circuits) to perform the equivalent operations described with mathematical language/notation, and such code may be conveniently translated (e.g., by compilers or other tools) into machine executable code that may be executed to control arbitrary physical devices (agents) operating with intelligence and efficiency in arbitrary physical environments, even when new actions are introduced (without necessarily requiring additional training for the new actions).

$${Q}_{w}^{π} ( s , a ) = {π}^{} [ {\sum }_{i = 0}^{∞} {γ}^{i} {r}_{t + 1} \vert {S}_{t} = s , {A}_{t} = a ] = {{π}^{} [ {\sum }_{i = 0}^{∞} {γ}^{i} {ϕ}_{t + 1} \vert {S}_{t} = s , {A}_{t} = a ]}^{T} ω = {{ψ}^{π} ( s , a )}^{T} ω \qquad Equation 1$$

In Equation 1, ψ^{π}(s, a) denotes SFs as a discounted sum (or an expected value of a discounted sum) of features ϕₜ₊₁ of a transition. γ denotes a discounted rate and w denotes a task vector.

$${\tilde{Q}}_{w}^{{π}_{z}} ( s , a ) = {\tilde{ψ} ( s , a , z )}^{T} w \approx {{ψ}^{π} ( s , a , z )}^{T} ω = {Q}_{w}^{π} ( s , a ) \qquad Equation 2$$

According to universal successor features approximators (USFAs), an approximator may be trained to output an approximated value function \tilde{Q}_{w}^{π}^{_{z}}(s, a) by inputting a policy vector z to the approximator. When it is defined that a policy vector space is equal to a task vector space and the policy vector z is equal to a task vector w, the electronic device 100 may approximate an optimal value-function Q_{w}^{π}^{_{w}}(s, a) for the task vector w according to Equation 2 above.

A state observer 130 may observe and output a current state of an agent in a given environment within which the agent performs actions. For example, the electronic device 100 may observe the current state of the agent using a camera, a sensor, a simulator, etc. in the electronic device 100. The current state may be obtained by other sources, e.g., environmental sensors, sensors of a device in which the agent is comprised, a location/position module/service, etc.

A task vector observer 140 may observe and output a task vector currently being solved by an agent. In an example, the task vector observer 140 may observe the task being solved by an agent. The task vector observer 140 may output the task vector based on a feature of the observed task. In an example, the task vector may be features and/or parameters of the observed task.

Source task vectors may be vectors used to train the value approximator 150. The task vector may be the outputted vector based on a feature of the observed task. The task vector may be represented by linear combination of the source task vectors. The task vector observer 140 may observe the task and output the task vector using various known methods.

The value approximator 150 may include the SFs approximator 151 and the value calculator 153. The electronic device 100 may determine an optimal value-function for a task vector using the value approximator 150. For example, the value approximator 150 may be trained to output an optimal value-function for a source task vector using the source task vector.

The value approximator 150 may approximate a value of a corresponding task in a corresponding policy, when a state s, a reference task vector z of the policy, and the task vector w are given. The SFs approximator 151 may output approximation SFs \tilde{ψ}(s, a, z) corresponding to a case of performing each action a for the given state s and the reference task vector z of the policy. The value calculator 153 may output an approximate value \tilde{Q}_{w}^{π}^{_{z}}=\tilde{ψ}(s, a, z)^{T}w of the reference task vector z of the policy for the task vector w by taking an inner product between the approximated SFs \tilde{ψ}(s, a, z) and the task vector w.

The task may be defined by a task vector w∈R^{d} and a set of source task vectors used for training may be defined as [symbol] . The variable π_{w}_{₁} denotes an optimal policy in a task for an arbitrary task vector w₁, Q_{w}_{₂}^{π}^{_{w1}} denotes a value-function with respect to a task vector w₂ of a policy π_{w}_{₁}, and \tilde{Q}_{w}_{₂}^{π}^{_{w1}} denotes an approximation trained for a value-function. ϵ_{w}_{₂}^{π}^{_{w1}} denotes an upper bound of an approximate error, s denotes a state of an agent, and a denotes an action of the agent.

The electronic device 100 may approximate SFs for a task vector ω using the SFs approximator 151 and approximate an optimal value-function (to be used for finding an approximal optimal value that is then adjusted before use) for the task vector ω using the approximated SFs.

For example, the electronic device 100 may approximate an optimal value-function Q_{w}_{₂}^{π}^{_{w1}}(s, a) for an arbitrary task vector w₂ of a policy based on the arbitrary task vector w₁, using the value approximator 150 as shown in Equation 3 below.

$$\vert {Q}_{{w}_{2}}^{{π}_{{w}_{1}}} ( s , a ) - {\tilde{Q}}_{{w}_{2}}^{{π}_{{w}_{1}}} ( s , a ) \vert \leq {ϵ}_{{w}_{2}}^{{π}_{{w}_{1}}} ( s , a ) , ∀ ( s , a ) ∈ \times , \qquad Equation 3$$

For example, the value approximator 150 may train the SFs approximator 151 (which may be any type of known USFA), and may approximate an optimal value-function for a task vector using the trained SFs approximator 151.

For the predetermined state s and the action a when inference is performed, the electronic device 100 may calculate an approximated optimal value-function Q_{w′}^{π}^{_{w′}}(s, a) for a target task vector w′, approximated optimal value-functions Q_{w}^{π}^{_{w}}(s, a), ∀w∈ [symbol] in source task vectors for upper bound inference, and approximated value-functions Q_{w′}^{π}^{_{w}}(s, a), ∀w∈ [symbol] in a target task vector of policies based on source task vectors for lower bound inference, using the value approximator 150.

The CGPI device 160 may include the upper bound inferencer 161, the lower bound inferencer 163, and the value corrector 165. The CGPI device 160 may output a corrected value in a target task by inferring an upper bound and a lower bound of an optimal value with respect to the target task vector w′ using approximated SFs for source tasks, that is, source task vectors w in [symbol] .

The upper bound inferencer 161 may calculate [symbol] _{s,a)} (s, a), which is an upper bound of an optimal value in a target task, based on values computed for source tasks. The lower bound inferencer 163 may calculate [symbol] (s, a), which is a lower bound of the optimal value.

The upper bound inferencer 161 may adjust a trade-off between optimal value correction accuracy (i.e., how accurate the upper bound is) and execution time by changing the execution time (duration) of a linear programming solver.

The value corrector 165 may output a value at high accuracy by correcting an approximated optimal value Q_{w′}^{π}^{_{w′}}(s, a) given for a target task using the calculated upper bound and the calculated lower bound and by reducing an approximate error.

The electronic device 100 may perform an action determined to have the highest estimated value, and may do so using the corrected value for the target task in a current state of the agent and/or environment.

Hereinafter, a process of inferring the upper bound and the lower bound of the optimal value with respect to the target task vector w′ is described.

When the target task vector w′, represented as W′= [symbol] α_{w}w (where α_{w}∈R, ∀w∈ [symbol] ), the optimal value-function with respect to the target task vector w′ may be bounded by the upper bound and the lower bound (as shown in Equation 4) when represented as

$${r}_{w}^{min} = {R}_{w} ( s , a ) and α = \{ {α}_{w} .$$

For example, the upper bound inferencer 161 and the lower bound inferencer 163 of the electronic device 100 may determine an upper bound [symbol] _{α}(s, a) and a lower bound [symbol] (s, a) of an approximated optimal value-function Q_{w′}^{π}^{_{w′}}(s, a), as shown in Equation 4.

$$( s , a ) \leq {Q}_{{w}^{′}}^{{π}_{{w}^{′}}} ( s , a ) \leq {U}_{{w}^{′} , 𝒯 , α} ( s , a ) , \qquad Equation 4$$

$$( s , a ) := {max}_{w ∈ 𝒯} [ {\tilde{Q}}_{{w}^{′}}^{{π}_{w}} ( s , a ) - {ϵ}_{{w}^{′}}^{{π}_{w}} ( s , a ) ] ,$$

$${, α}_{} ( s , a ) := {\sum }_{w ∈ 𝒯} max \{ {α}_{w} ( {\tilde{Q}}_{w}^{{π}_{w}} ( s , a ) + {ϵ}_{w}^{{π}_{w}} ( s , a ) ) , {α}_{w} \frac{1}{1 - γ} {r}_{w}^{min} \} .$$

In Equation 4, a lower bound of an optimal value-function in a task vector w′ may be established according to Equation 5. For example, the electronic device 100 may determine the lower bound of the optimal value-function based on an approximation \tilde{Q}_{w′}^{π}^{_{w}}(s, a) and an upper bound Q_{w}_{₂}^{π}^{_{w1}}(s, a) of an approximate error of the optimal value-function for the task vector w′ of policies based on source task vectors.

$${Q}_{{w}^{′}}^{{π}_{{w}^{′}}} ( s , a ) \geq {Q}_{{w}^{′}}^{{π}_{w}} ( s , a ) \geq {max}_{w ∈ 𝒯} [ {\tilde{Q}}_{{w}^{′}}^{{π}_{w}} ( s , a ) - {ϵ}_{{w}^{′}}^{{π}_{w}} ( s , a ) ] . \qquad Equation 5$$

The upper bound of Equation 4 may be established as shown in Equation 6.

$$Equation 6$$

$$\begin{matrix}{Q}_{{w}^{′}}^{{π}_{{w}^{′}}} ( s , a ) = {α}_{w} ( {Q}_{w}^{{π}_{{w}^{′}}} ( s , a ) - \frac{1}{1 - γ} {r}_{w}^{min} ) + \frac{1}{1 - γ} {\sum }_{w ∈ 𝒯} {α}_{w} {r}_{w}^{min} \\ \leq {\sum }_{w ∈ 𝒯} max \{ {α}_{w} ( {Q}_{w}^{{π}_{{w}^{′}}} ( s , a ) - \frac{1}{1 - γ} {r}_{w}^{min} ) , 0 \} + \frac{1}{1 - γ} {\sum }_{w ∈ 𝒯} {α}_{w} {r}_{w}^{min} \\ \leq {\sum }_{w ∈ 𝒯} max \{ {α}_{w} ( {Q}_{w}^{{π}_{w}} ( s , a ) - \frac{1}{1 - γ} {r}_{w}^{min} ) , 0 \} + \frac{1}{1 - γ} {\sum }_{w ∈ 𝒯} {α}_{w} {r}_{w}^{min} \\ = {\sum }_{w ∈ 𝒯} \{ max \{ {α}_{w} ( {Q}_{w}^{{π}_{w}} ( s , a ) - \frac{1}{1 - γ} {r}_{w}^{min} ) , 0 \} + \frac{1}{1 - γ} {\sum }_{w ∈ 𝒯} {α}_{w} {r}_{w}^{min} \\ = {\sum }_{w ∈ 𝒯} max \{ {α}_{w} {Q}_{w}^{{π}_{w}} ( s , a ) - {α}_{w} \frac{1}{1 - γ} {r}_{w}^{min} \} \\ \leq {\sum }_{w ∈ 𝒯} max \{ {α}_{w} ( {\tilde{Q}}_{w}^{{π}_{w}} ( s , a ) + {ϵ}_{w}^{{π}_{w}} ( s , a ) ) + {α}_{w} \frac{1}{1 - γ} {r}_{w}^{min} \} .\end{matrix}$$

In Equation 4 above, a task vector w′= [symbol] α_{w}w represented as an arbitrary linear combination of source task vectors in a set [symbol] of the source task vectors may have a wider range than a task vector represented as a positive conical combination of the source task vectors in the set [symbol] of the source task vectors.

According to Equation 6, an upper bound may be calculated using an approximation of an optimal value-function and the arbitrary linear combination of the source task vectors.

The electronic device 100 may correct an optimal value-function for a task vector using an upper bound and a lower bound. The electronic device 100 may correct an optimal value-function \tilde{Q}_{w′}^{π}^{_{z}}(s, a) for the approximated task vector w′ using the value corrector 165, as shown in Equation 7 below. The electronic device 100 may determine an optimal policy π_{CGPI}(s) for the task vector w′ using the optimal value-function Q_{w′}^{π}^{_{z}}(s, a) for the corrected task vector w′.

$${π}_{CGPI} ( s ) ∈ {arg max}_{a} [ min \{ max \{ {\tilde{Q}}_{{w}^{′}}^{{π}_{z}} ( s , a ) , ( s , a ) \} , {U}_{{w}^{′} , 𝒯 , ξ ( {w}^{′} , 𝒯 , s , a )} ( s , a ) \} ] \qquad Equation 7$$

In Equation 7, min{max{Q_{w′}^{π}^{_{z}}(s, a), [symbol] (s, a)}, [symbol] _{s,a)}(s, a)} refers to a corrected optimal value-function for a task vector w′. In Equation 7 above, [symbol] denotes a set that determines which approximated value of a function is to be used for task vectors. For example, [symbol] may be {w′} (i.e., [symbol] ={w′}).

The electronic device 100 may correct an optimal value-function \tilde{Q}_{w′}^{π}^{_{z}}(s, a) for the approximated task vector w′ to be less than or equal to an upper bound [symbol] _{s,a)}(s, a) and greater than or equal to a lower bound [symbol] (s, a).

An operation in which the electronic device 100 determines an optimal policy for the state s and the action a at the inference time according to Equation 7 may be referred to as CGPI. Equation 7 represents an improvement in generalized policy improvement (GPI), which is a methodology for deriving a new policy having a value greater than or equal to a value of an existing policy in all states and operations (or actions) when a value-function for various policies in a specific task is given.

According to Equation 7 above, the electronic device 100 may perform inference more accurately for a new task by correcting the approximated optimal value-function using the upper bound and/or the lower bound.

The upper bound inferencer 161 may adjust a trade-off between optimal value correction accuracy and execution time (duration) by changing the execution time (duration) of a linear programming solver. In Equations 4 to 7 above, ξ(⋅) denotes a function for determining a coefficient α to represent the task vector w′ as a linear combination of source task vectors. For example, ξ(w′, [symbol] , s, a) denotes a function for determining the coefficient α of the source task vectors to be used for calculating the upper bound. For example, ξ(w′, [symbol] , s, a) may be defined as shown in Equation 8 or Equation 9.

$$ξ ( {w}^{′} , , s , a ) := {arg min}_{{\{ {α}_{w} \}}_{w ∈ 𝒯}} {U}_{{w}^{′} , 𝒯 , {\{ {α}_{w} \}}_{w ∈ 𝒯}} ( s , a ) subject to {w}^{′} = {\sum }_{w ∈ 𝒯} {α}_{w} w \qquad Equation 8$$

$$ξ ( {w}^{′} , 𝒯 , s , a ) := {\{ {α}_{w} \}}_{w ∈ 𝒯} subject to {w}^{′} = {\sum }_{w ∈ 𝒯} {α}_{w} w \qquad Equation 9$$

When the electronic device 100 calculates ξ(w′, [symbol] , s, a) accurately according to Equation 8 and calculates an upper bound according to a calculated result, the electronic device 100 may most reduce an approximation error of the optimal value-function for the task vector.

Since [symbol] _{{α}_{_{w}}_{}w∈T}(s, a) of Equation 8 above is piecewise linear, the solution of Equation 8 may be calculated by linear programming.

When the electronic device 100 calculates ξ(w′, [symbol] , s, a) according to Equation 9 and calculates the upper bound using an arbitrary a that satisfies w′= [symbol] α_{w}w according to a calculated result, the electronic device 100 may quickly calculate the upper bound of the optimal value-function.

Equations 8 and 9 above may represent a trade-off between performance and execution time in calculating the upper bound of the approximated optimal value-function. For example, the electronic device 100 may calculate the upper bound of the optimal value-function according to Equation 8 in a predetermined calculation time or determine the number of combinations of a linear combination by a predetermined threshold value and calculate the upper bound of the optimal value-function according to Equation 8.

The electronic device 100 may reduce an approximation error by correcting values of an approximated optimal value using a relationship of different task vectors, rather than relying only on the approximated optimal value according to a value-function approximator, using the CGPI device 160 including the upper bound inferencer 161 and the lower bound inferencer 163. The electronic device 100 may improve the performance of an agent for a new task (one that it has not previously learned). The correcting of an optimal value-function in the new task may be applied to the inference time of SFs agents based on a pre-trained function approximator without training a new agent or newly training the existing agent.

Referring to FIG. 1, the electronic device 100 may further include a common feature approximator 131. For example, the common feature approximator 131 may be trained to output a transition feature using the state s observed in the state observer 130. For example, the common feature approximator 131 may be a neural network model trained to predict the transition feature from the state s even when information about the transition feature configuring a reward function is not given.

The common feature approximator 131 may increase both training speed and performance using a commonly used feature approximator instead of individually configuring the SFs approximator 151 and a transition feature approximator.

Referring to FIG. 1, the value approximator 150 may further include a task vector approximator 155. For example, the task vector approximator 155 may be a neural network model trained to predict a task vector using task information observed from a task information observer 141 even when information about the task vector is not given.

The task vector approximator 155 may be used to represent a reward function as an approximated transition feature and as a task vector through training even when a method of representing the reward function as an inner product of the transition feature and the task vector is unknown or does not exist.

For example, task information g∈G may be given to an agent. An approximated feature d and an approximated task vector \tilde{ω} in a reward function may be output using the common feature approximator 131 and the task vector approximator 155. Training of the common feature approximator 131 may be performed simultaneously with training of the SFs approximator 151.

For example, the common feature approximator 131, the task vector approximator 155, and the SFs approximator 151 to output \tilde{ϕ}, \tilde{ω}, \tilde{ψ} may be trained to minimize [symbol] _{g˜T}_{_{g}}_{,z˜D}_{_{z}}_{^{g}}_{(⋅|g),(s,a,r,s′)˜μ}[ [symbol] ^{ψ}+ [symbol] ^{Q}] using gradient descent. [symbol] ^{ψ} and [symbol] ^{Q} may be defined as shown in Equation 10 below.

$${ψ}^{} = \frac{1}{d} {‖ \tilde{ϕ} ( s , a , {s}^{′} ) + γ {\tilde{ψ}}^{( k )} ( {s}^{′} , {a}^{′} , z ) - \tilde{ψ} ( s , a , z ) ‖}^{2} \qquad Equation 10$$

$${ℒ}^{Q} = {\{ r + γ {{\tilde{ψ}}^{( k )} ( {s}^{′} , {a}^{′} , z )}^{T} {\tilde{ω}}^{( k )} ( z ) - {\tilde{ψ} ( s , a , z )}^{T} \tilde{ω} ( z ) \}}^{2}$$

Equation 10 is an equation for a k-th iteration, a′ denotes argmax_{b}\tilde{ψ}^{(k)}(s′, b, z)^{T}\tilde{ω}^{(k)}(z), (k) denotes a target, [symbol] _{g} denotes a source task information set, and D_{z}^{g}(⋅|g) denotes a policy vector distribution in task information and sampling distribution μ. For example, the target may represent a function to be fixed in a trained state from the k-th iteration of training according to the reinforcement learning method to an immediately preceding iteration (e.g., a k−1-th iteration).

The electronic device 100 may apply transfer learning to various kinds of tasks because corresponding vectors may be predicted through training even when not given a transition feature or a task vector that may linearly separate a reward function using the common feature approximator 131 and the task vector approximator 155.

For example, the electronic device 100 may perform an approximation in a form in which transfer learning is possible using reward data given at time of learning and solve a new task using the CGPI device 160 when the new task is given, even when a state is observed in a first-person view through a camera and a corresponding task is to be performed.

Referring to FIG. 1, a policy improver may further include a minimum value approximator 167. The minimum value approximator 167 may be trained to output a minimum value for a given task for a specific state and action.

For example, the minimum value approximator 167 may be trained to output a minimum value using an output of the common feature approximator 131 and an output of the task information observer 141.

When an upper bound [symbol] _{α}(s, a) is calculated in Equation 4, the electronic device 100 may calculate the upper bound [symbol] _{α}(s, a) by applying the minimum value (instead of

$${r}_{w}^{min} = {R}_{w} ( s , a )$$

For example, the upper bound inferencer 161 may determine an upper bound by substituting the minimum value instead of

$${α}_{w} \frac{1}{1 - γ} {r}_{w}^{min}$$

in Equation 4 above.

Using the minimum value approximator 167, the electronic device 100 may calculate an upper bound and a lower bound using the minimum value approximated by the trained minimum value approximator 167, even when information about a minimum reward value for each task vector is not given. The electronic device 100 may thus narrow a range of optimal value-functions for an approximated task vector and thereby improve transition performance by determining the upper bound using the minimum value.

The electronic device 100 may apply transfer learning using the minimum value approximator 167, even when the electronic device 100 operates in a complex or unknown physical environment.

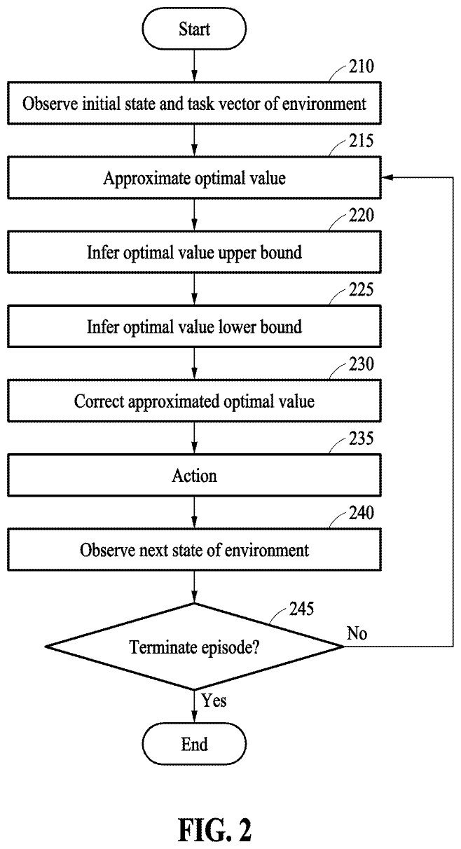

FIG. 2 illustrates an example operation of transferring (adapting) a reinforcement-trained agent to a new task, according to one or more embodiments.

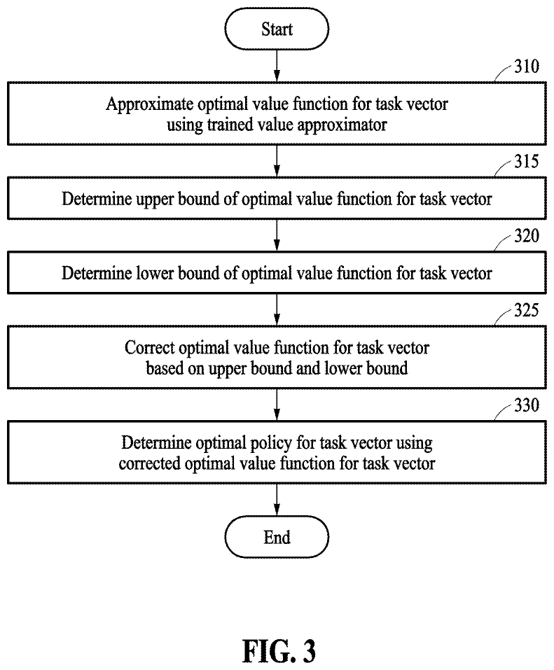

FIG. 2 shows an operation in one episode in which the electronic device 100 (which includes a reinforcement-trained agent using SFs) performs a new task by applying a CGPI ( [symbol] ={w′}). For example, the electronic device 100 may be understood to be substantially the same as the reinforcement-trained agent. Details of some of the steps of FIG. 2 are described provided with reference to FIG. 3.

In operation 210, the electronic device 100 may observe an initial state and a task vector of an environment, for example, when an episode starts. The electronic device 100 may identify a task vector w′ representing a task of the electronic device 100 and an initial state s₀. For example, the electronic device 100 may respectively receive the task vector w′ and the initial state s₀ from the state observer 130 and the task vector observer 140.

Operations 215, 220, 225, and 230 may be for obtain, for each iteration of an episode, a corrected optimal value-function based on an observed state of the current iteration. Operations 235 and 240 may perform an action to maximize a value according to the corrected optimal value-function and may observe a next state (to be used in the next iteration).

In operation 215, the electronic device 100 may approximate an optimal value. For example, the electronic device 100 may approximate the task vector w′ and a corresponding optimal value Q_{w′}^{π}^{_{w′}}(s, a) for the action of the current iteration using the trained value approximator 150.

In operations 220 and 225, the electronic device 100 may infer an upper bound and a lower bound of the approximated optimal value Q_{w′}^{π}^{_{w′}}(s, a). For example, the electronic device 100 may calculate an upper bound [symbol] _{s,a)}(s, a) and a lower bound [symbol] (s, a) using the upper bound inferencer 161 and the lower bound inferencer 163.

In operation 230, the electronic device 100 may correct the approximated optimal value Q_{w′}^{π}^{_{w′}}(s, a). For example, the electronic device 100 may correct the approximated optimal value Q_{w′}^{π}^{_{w′}}(s, a) according to min{max{\tilde{Q}_{w′}^{π}^{_{w′}}(s, a), [symbol] (s, a)}, [symbol] _{s,a)}(s, a)} (i.e., the inferred optimal upper and lower bounds) using the value corrector 165.

In operation 235, the electronic device 100 may perform an action. The electronic device 100 may (i) calculate a value for each action, (ii) select an action in which an optimal value is maximized using the corrected min{max{Q_{w′}^{π}^{_{w′}}(s, a), [symbol] (s, a)}, [symbol] _{s,a)}(s, a)}, and (iii) perform the action in operation 235. In some embodiments, the electronic device 100 may not be the device itself that performs the action, but rather there may be a device controlled by the electronic device.

In operation 240. the electronic device 100 may observe a next state of the environment. In operation 245, when repetition of an episode (iteration) is not terminated, the electronic device 100 may repeat operations 215, 220, 225, 230, 235, and 240 until an episode/iteration is terminated by operation 245.

FIG. 3 illustrates an example operation of a method of transferring reinforcement learning, according to one or more embodiments.

In operation 310, the electronic device 100 may approximate an optimal value-function for a task vector using the trained value approximator 150. For example, the electronic device 100 may approximate an optimal value-function for an arbitrary task vector, as shown in Equation 3 above.

In operation 315, the electronic device 100 may determine an upper bound of an optimal value-function for a task vector. In operation 320, the electronic device 100 may determine a lower bound of the optimal value-function for the task vector. For example, the electronic device 100 may determine the upper bound and the lower bound as shown in Equation 4 above.

The electronic device 100 may determine the upper bound and the lower bound using approximated optimal values Q_{w′}^{π}^{_{w}}(s, a), ∀w∈ [symbol] in source task vectors and approximated values Q_{w}^{π}^{_{w}}(s, a), ∀w∈ [symbol] in a target task vector of policies based on the source task vectors.

In operation 325, the electronic device 100 may correct an optimal value-function for a task vector based on an upper bound and a lower bound. The electronic device 100 may correct the optimal value-function for the task vector so that the optimal value-function for the task vector is less than or equal to the upper bound and greater than or equal to the lower bound.

For example, the electronic device 100 may correct an optimal value-function \tilde{Q}_{w′}^{π}^{_{z}}(s, a) for a task vector w to min{max{\tilde{Q}_{w′}^{π}^{_{z}}(s, a), [symbol] (s, a)}, [symbol] _{s,a)}(s, a)}.

In operation 330, the electronic device 100 may determine an optimal policy for a task vector using a corrected optimal value-function for a task vector. For example, the electronic device 100 may determine a policy performing the action a that maximizes the corrected optimal value-function as shown in Equation 7 above.

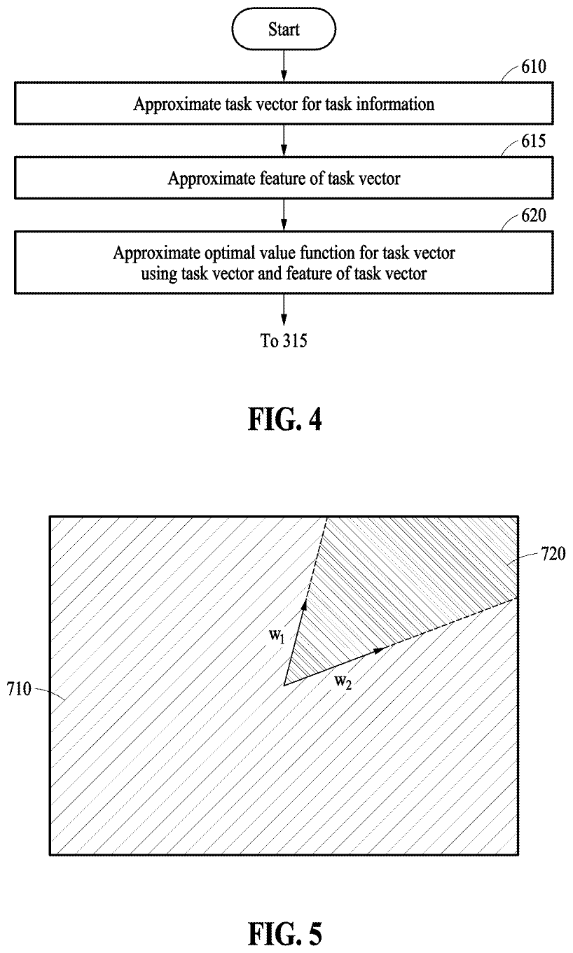

FIG. 4 illustrates an example of an operation of a method of approximating a minimum value-function.

Referring to FIG. 4, in operation 610, the electronic device 100 may approximate a task vector for task information. For example, the electronic device 100 may approximate the task vector from the task information measured by the task information observer 141 using the trained task vector approximator 155.

In operation 615, the electronic device 100 may approximate a feature of the task vector. For example, the electronic device 100 may approximate the feature from a state measured by the state observer 130 using the trained common feature approximator 131.

In operation 620, the electronic device 100 may approximate an optimal value-function for the task vector using the task vector and the feature of the task vector. For example, the electronic device 100 may approximate SFs using the SFs approximator 151. The electronic device 100 may calculate the optimal value-function using the approximated SFs using the value calculator 153.

In operation 610, operation 615 and operation 620, the electronic device 100 may approximate a feature of the task vector, may approximate a feature of the task vector, and may approximate an optimal value-function for the task vector, using various known methods.

The SFs approximator 151, the common feature approximator 131, and the task vector approximator 155 may be trained according to the reinforcement learning method. In addition, the minimum value approximator 167 in FIG. 1 may be trained according to the reinforcement learning method.

FIG. 5 illustrates an example of a range of task vectors, according to one or more embodiments.

A task vector may be represented as an arbitrary linear combination of source task vectors in a set [symbol] of source task vectors.

For example, in Equation 3 above, a task vector w′= [symbol] α_{w}w (represented as the arbitrary linear combination of the source task vectors in the set [symbol] of the source task vectors) may have a wider range than a task vector represented as a positive conical combination of the source task vectors in the set [symbol] of the source task vector.

FIG. 5 shows an area of a target task vector that may bound an approximated optimal value when a task vector space is two dimensions and [symbol] is {w₁, w₂} (i.e., [symbol] ={w₁, w₂}).

In FIG. 5, an area 720 shows a range of task vectors represented as a positive conical combination of the source task vectors in the set [symbol] of the source task vector. An area of the target task vector for bounding an existing optimal value may be limited to the area 720. An area of a task vector w′= [symbol] α_{w}w represented as an arbitrary linear combination of the source task vectors in the set [symbol] of the source task vector includes the area 710 and the area 720.

As shown in FIG. 5, the electronic device 100 may determine an upper bound and a lower bound of an approximated optimal value for the task vector w′ of a wider area than an existing area. Accordingly, the electronic device 100 may perform transfer learning using reinforcement-trained policies for various task vectors.

The electronic device 100 and the method of transferring reinforcement learning described with reference to FIGS. 1 to 5 may be applied to various fields. The electronic device 100 and the method of transferring reinforcement learning may be applied to a case in which inference is performed using an agent trained according to an environment and/or a task that is/are different from when reinforcement learning was performed.

For example, the electronic device 100 and the method of transferring reinforcement learning described with reference to FIGS. 1 to 5 may be applied to a non-player character (NPC) in a game for providing an experience in response to various time points and users and training and/or control applications that provide content.

For example, the electronic device 100 and the method of transferring reinforcement learning described with reference to FIGS. 1 to 5 may be applied to training and/or control a robot arm having generalized performance such as assembly, processing, quality inspection, defect detection, etc. in various processes.

The electronic device 100 and the method of transferring reinforcement learning may be applied to a case in which agents performing different tasks are required because an environment in which an agent performs an action is complex, e.g., navigation tasks.

In addition, the electronic device 100 and the method of transferring reinforcement learning may be applied to an agent that performs a task vector different from the task vector at the learning time in an environment in which information about a feature and/or a task vector to represent a reward function is limited.

The computing apparatuses, the vehicles, the electronic devices, the processors, the memories, the displays, the information output system and hardware, the storage devices, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
a memory electrically connected with the one or more processors and storing instructions configured to cause the one or more processors to:
approximate an optimal value-function for a task vector using a value approximator trained to output a minimum value-function using a state of an agent and source task vectors;
determine an upper and lower bound of the optimal value-function for the task vector;
correct the optimal value-function for the task vector based on the upper bound and the lower bound; and
determine an optimal policy for the task vector using the corrected optimal value-function for the task vector.

2. The electronic device of claim 1, wherein the task vector is represented as a linear combination of the source task vectors.

3. The electronic device of claim 2, wherein the instructions are further configured to cause the one or more processors to:
determine a number of combinations of the linear combination of the source task vectors to represent the task vector according to a threshold; and
determine the upper bound according to one of the determined linear combinations of the task vectors.

4. The electronic device of claim 1, wherein the lower bound is determined based on an approximation of, and an approximation error of, the optimal value-function.

5. The electronic device of claim 1, wherein the upper bound is determined based on an arbitrary linear combination of the source task vectors to represent the task vector.

6. The electronic device of claim 1, wherein the instructions are further configured to cause the one or more processors to correct the optimal value-function in a range of less than or equal to the upper bound and greater than or equal to the lower bound.

7. The electronic device of claim 1, wherein the instructions are further configured to cause the one or more processors to:
approximate a minimum value for the task vector using a minimum value approximator trained to output a minimum value for the source task vectors; and
determine the upper bound using the minimum value for the task vector.

8. The electronic device of claim 1, wherein the optimal policy comprises a neural network model.

9. A method of transferring reinforcement learning, the method comprising:
approximating an optimal value-function for a task vector using a value approximator trained to output a minimum value-function using a state of an agent and source task vectors;
determining an upper bound of the optimal value-function for the task vector;
determining a lower bound of the optimal value-function for the task vector;
correcting the optimal value-function for the task vector based on the upper bound and the lower bound; and
determining an optimal policy for the task vector using the corrected optimal value-function for the task vector.

10. The method of claim 9, wherein the task vector is represented as a linear combination of the source task vectors.

11. The method of claim 10, wherein the determining of the upper bound of the optimal value-function for the task vector comprises:
determining a number of combinations of the linear combination of the source task vectors to represent the task vector by a predetermined threshold; and
determining the upper bound according to a combination of the linear combination of the source task vectors.

12. The method of claim 9, wherein the lower bound is determined based on an approximation of, and an approximation error of, the optimal value-function for the task vector of policies based on the source task vectors.

13. The method of claim 12, wherein the policies comprise respective neural networks trained with respect to the source task vectors.

14. The method of claim 9, wherein the upper bound is determined based on a combination of the linear combination of the source task vectors to represent the task vector.

15. The method of claim 9, wherein the correcting of the optimal value-function for the task vector comprises correcting the optimal value-function for the task vector in a range of less than or equal to the upper bound and greater than or equal to the lower bound.

16. The method of claim 9, further comprising:
approximating a minimum value for the task vector using a minimum value approximator trained to output a minimum value for the source task vectors,
wherein the determining of the upper bound comprises determining the upper bound using the minimum value for the task vector.

17. A method of transferring reinforcement learning, the method comprising:
approximating a task vector using a task vector approximator trained to output source task vectors using source task information of source tasks;
approximating a feature of the task vector using a feature approximator trained to output a feature of the source task vector based on a state of an agent;
approximating an optimal value-function for the task vector using the task vector and the feature of the task vector;
determining an upper bound of the optimal value-function;
determining a lower bound of the optimal value-function;
correcting the optimal value-function based on the upper bound and the lower bound; and
determining an optimal policy for the task vector using the corrected optimal value-function.

18. The method of claim 17, wherein the task vector is represented as a linear combination of the source task vectors.

19. The method of claim 17, wherein the lower bound is determined based on an approximation and an approximation error of the optimal value-function, wherein the approximation error is based on the source task vectors.

20. The method of claim 17, wherein the upper bound is determined based on one of multiple linear combinations of the source task vectors.
